(19) United States
(12) Patent Application Publication
(10) Pub. No.: US 2026/0030410 A1
(43) Pub. Date: Jan. 29, 2026

(54) SIMULATION METHOD FOR MARINE SEISMIC GROUND MOTION APPLICABLE TO SEISMIC ANALYSIS OF OFFSHORE WIND POWER

(71) Applicant: Sichuan University, Chengdu (CN)

(72) Inventors: Mengtao WU, Chengdu (CN); Qibo SU, Chengdu (CN); Tao LI, Chengdu (CN); Kaoshan DAI, Chengdu (CN); Jianbo LI, Chengdu (CN); Jianze WANG, Chengdu (CN); Zhenning BA, Chengdu (CN); Jun XU, Chengdu (CN)

(73) Assignee: Sichuan University, Chengdu (CN)

(21) Appl. No.: 19/247,146

(22) Filed: Jun. 24, 2025

(30) Foreign Application Priority Data
Jul. 29, 2024 (CN) 202411020731.2

(51) Int. Cl. G06F 30/23; G06F 113/06

(52) U.S. Cl. CPC G06F 30/23; G06F 30/20; G06F 2113/06

(57) ABSTRACT

A simulation method for a marine seismic ground motion applicable to seismic analysis of offshore wind power includes: calculating a transfer function of a seismic ground motion for a bedrock site with an overlying seawater layer; modifying a response spectrum on the basis of a design modification factor (DMF) model, and calculating a power spectral density function of the seismic ground motion; calculating a spatially varying power spectral density matrix of the seismic ground motion; simulating the seismic ground motion in a frequency domain, and obtaining a non-stationary acceleration time history of the seismic ground motion; and using the simulated seismic ground motion as an input for seismic response analysis of an offshore wind power structure. The disclosure provides more accurate seismic ground motion inputs for seismic response analysis and seismic design of offshore wind power structures.

### CROSS-REFERENCE TO RELATED APPLICATIONS

This application claims priority to Chinese Patent Application No. 202411020731.2, filed on Jul. 29, 2024, the content of which is incorporated herein by reference in its entirety.

### TECHNICAL FIELD

The disclosure relates to a simulation method for seismic ground motions, and especially relates to a simulation method for a marine seismic ground motion applicable to seismic analysis of offshore wind power.

### BACKGROUND

Featuring stability, practicality and environmental protection, wind power generation has made rapid progress in recent years, and particularly, a large number of offshore wind farms are established in coastal regions of China. Wind power structure (such as wind turbine tower) is an elongated towering structure with large mass at the top and relatively long-period characteristics, and it tends to show complex and variable damage modes under the effect of different seismic ground motions. Accordingly, the seismic issue of offshore wind power is particularly important.

Lacking measured seismic ground motion data on the seabed and seismic design codes specifically for offshore wind power structures, most of the current seismic analyses for offshore wind power use onshore seismic ground motion records for calculation. However, many studies have shown that, affected by seawater layer, submarine soil layer, etc., there is a significant difference between properties of marine seismic ground motion and land seismic ground motion, and the traditional seismic performance analysis method for onshore wind power structures is inapplicable to the study of seismic performance of offshore wind power structures. Therefore, conducting marine seismic ground motion simulation is an effective solution. Upon the offshore wind farms are affected by earthquakes, there is a relatively large difference between the seismic waves of wind towers at different locations, this is because of the traveling wave effect caused by the different arrival times of seismic waves at different points of the seismic ground motion and the coherence effect caused by the refraction and reflection of seismic waves on the way of propagation. Therefore, the simulation on the marine seismic ground motion requires considering both the effect of the seawater layer and the submarine soil layer, as well as their spatial effects. To consider the spatial effects of seismic ground motion, some scholars use traveling wave method, coherence function, spectral representation method, etc. to conduct spatially varying seismic ground motion simulation. However, these methods are obtained on the basis of land site, without considering the properties of the marine seismic ground motion as well as the influence of the seawater layer and the submarine soil layer. Obviously, there is an urgent need to develop a simulation method for a seismic ground motion applicable to seismic analysis of offshore wind power and capable of considering the spatial effects.

### SUMMARY

The disclosure provides a simulation method for a marine seismic ground motion applicable to seismic analysis of offshore wind power, aiming to overcome the shortcoming that a simulation method for a land seismic ground motion is utilized to conduct seismic analysis of offshore wind power structure due to the lack of marine seismic ground motion records.

The technical solution employed by the disclosure is a simulation method for a marine seismic ground motion applicable to seismic analysis of offshore wind power, including the following steps:
step S1: calculating dynamic stiffness matrices of a seawater layer and a bedrock, and obtaining a transfer function of a seismic ground motion for a bedrock site with an overlying seawater layer on the basis of a dynamic equilibrium equation;
step S2: on the basis of a seismic ground motion selection criterion with a minimum deviation between an average response spectrum and a design spectrum of a wind turbine tower, performing statistical regression to establish a design modification factor (DMF) model for a quantile spectrum, modifying a standard response spectrum with a damping ratio of 5% in a code, and then determining a power spectral density function of the seismic ground motion on the basis of a modified response spectrum of the seismic ground motion;
step S3: calculating a spatially varying power spectral density matrix of the seismic ground motion on the basis of the transfer function, the power spectral density function and a coherence loss function;
step S4: simulating the seismic ground motion in a frequency domain, using an inverse Fourier transform, and multiplying by a shape function to obtain a non-stationary acceleration time history of the seismic ground motion; and
step S5: using the simulated seismic ground motion as an input for seismic of wind power, and then performing seismic response analysis of an offshore wind power structure.

Furthermore, in step S1, assuming seawater is an ideal fluid incapable of withstanding a shear stress and capable of only propagating compressional waves (P waves) rather than shear waves (S waves), a motion under seismic excitation is expressed using a fluid mass conservation equation, an Euler equation and a thermodynamic equation, a partial differential equation is solved to obtain displacement and stress expressions for mass points at a top and a bottom of the seawater layer, and on the basis of a relationship between displacement and load, the dynamic stiffness matrices and the dynamic equilibrium equation are obtained; and the dynamic stiffness matrices and the dynamic equilibrium equation are integrated to obtain the transfer function of the seismic ground motion for the bedrock site with the overlying seawater layer.

Furthermore, in step S3, the power spectral density function is solved on the basis of the response spectrum obtained in step S2:

$$S ( ω ) = - \frac{ξ}{π ω} \frac{{S}_{a}^{2} ( ω , ξ )}{ln ( - \frac{π}{{T}_{d} ω} ln P )} ;$$

in the formula, ξ is a damping ratio, Sₐ²(ω, ξ) is a seismic acceleration response spectrum, T_{d} is a seismic duration, P is a probability which does not exceed a target response spectrum; and ω represents a circular frequency;
a self-power spectral density function at a point a of the site is:

$${S}_{a a} ( ω ) = {\vert {H}_{a} ( i ω ) \vert}^{2} {S}_{b r} ( ω ) ;$$

in the formula, |Hₐ(iω)| represents a transfer function of the seismic ground motion at the point a, S_{br}(ω) represents a power spectral density function of the seismic ground motion on a free surface of the bedrock; and i represents an imaginary unit;
a cross-power spectral density function S_{ab}(iω) of the seismic ground motion between points a and b is:

$${S}_{a b} ( i ω ) = {H}_{a} ( i ω ) {H}_{b}^{*} ( i ω ) {γ}_{{a}^{′} {b}^{′}} ( i ω ) {S}_{b r} ( ω ) ;$$

in the formula, a superscript * represents a complex conjugate; Hₐ(iω) represents a transfer function of the seismic ground motion at the point a, describing a variation of a seismic wave transmitted from the bedrock to the point a; H*_{b}(iω) represents a complex conjugate of a transfer function of a seismic ground motion at a point b, for processing a relationship between phase and amplitude of a seismic ground motion signal in the frequency domain; and γ_{a′b′}(iω) represents a coherent loss function between the points a and b of the bedrock; and
a power spectral density function matrix S(iω) of a seismic ground motion for n points in the site is obtained:

$$S ( i ω ) = [ \begin{matrix}{S}_{11} ( ω ) & … & {S}_{1 n} ( ω ) \\ ⋮ & ⋱ & ⋮ \\ {S}_{n 1} ( ω ) & … & {S}_{nn} ( ω )\end{matrix} ] .$$

Furthermore, in step S4, a power spectral density function matrix of the seismic ground motion obtained in step S3 is decomposed to obtain a lower triangular complex matrix L(iω) and a Hermitian matrix L^{H}(iω):

$$S ( i ω ) = L ( i ω ) {L}^{H} ( i ω ) ;$$

a seismic ground motion at the point a can be simulated in a frequency domain:

$${U}_{a} ( i {ω}_{n} ) = {\sum }_{m = 1}^{a} {B}_{a m} ( {ω}_{n} ) [ cos {α}_{a m} ( {ω}_{n} ) + i sin {α}_{a m} ( {ω}_{n} ) ] , n = 1 , 2 , … , N ;$$

$${B}_{a m} ( {ω}_{n} ) = \sqrt{△ω} \vert {L}_{a m} ( i {ω}_{n} ) \vert ;$$

$${α}_{a m} ( {ω}_{n} ) = {tan}^{- 1} ( \frac{I m [ {L}_{a m} ( i {ω}_{n} ) ]}{Re [ {L}_{a m} ( i {ω}_{n} ) ]} ) + {φ}_{m n} ( {ω}_{n} ) ;$$

in the formulas, Bₐₘ(ωₙ) is an amplitude of a simulated seismic ground motion, aₐₘ(ωₙ) is a phase angle of the simulated seismic ground motion, Δω is a frequency interval, Lₐₘ(iωₙ) is an element in a matrix L(iω) corresponding to a frequency ωₙ and a position am, containing amplitude and phase information of the seismic ground motion, where a represents a specific spatial point, and m represents a corresponding frequency component; φₘₙ(ωₙ) is a uniformly distributed random variable within an interval of [0, 2π]; a numerator Iₘ[Lₐₘ(iωₙ)] represents an imaginary part of Lₐₘ(iωₙ); and a denominator Re[Lₐₘ(iωₙ)] represents a real part of Lₐₘ(iωₙ); and
performing the inverse Fourier transform on Uₐ(iωₙ) to obtain a stationary seismic ground motion acceleration uₐ(t) at the point a in a time domain, multiplying uₐ(t) by an intensity envelope function to obtain a final simulated non-stationary acceleration time history of the seismic ground motion at the point a.

Furthermore, in step S5, a finite element model of the wind power structure is established in OpenSees software, a simulated acceleration time history of the seismic ground motion is used as an input to calculate structural responses such as a tower-top displacement, a tower-top acceleration and a tower-bottom internal force of the wind power structure under a seismic action.

The disclosure has the following advantages and effects.

The disclosure provides a simulation method for a marine seismic ground motion applicable to seismic analysis of offshore wind power, overcoming the shortcoming that a simulation method for a land seismic ground motion is utilized to conduct seismic analysis of offshore wind power structure due to the lack of marine seismic ground motion records. The engineering properties of wind power structures in a low damping ratio are considered, the spatial variability within the wind farm is reflected, and more accurate seismic ground motion inputs are provided for the seismic response analysis and seismic design of offshore wind power structures.

### BRIEF DESCRIPTION OF THE DRAWINGS

FIG. 1 is a seismic ground motion (EW direction) simulated on the basis of the method of the disclosure.

FIG. 2 is a seismic ground motion (NS direction) simulated on the basis of the method of the disclosure.

FIG. 3 is a seismic ground motion (UD direction) simulated on the basis of the method of the disclosure.

FIG. 4 shows a tower-top displacement of a 1.5 MW wind power tower under a simulated seismic ground motion, where the solid line represents the EW direction and the dashed line represents the UD direction.

FIG. 5 shows a flowchart of a simulation method for a marine seismic ground motion applicable to seismic analysis of offshore wind power according to the disclosure.

### DETAILED DESCRIPTION OF THE EMBODIMENTS

The disclosure is described more clearly and completely with reference to the attached drawings and specific embodiments below. The embodiments described are only some, rather than all embodiments of the disclosure. On the basis of the embodiments of the disclosure, all other embodiments obtained by those ordinary skilled in the art without creative efforts fall within the scope of protection of the disclosure.

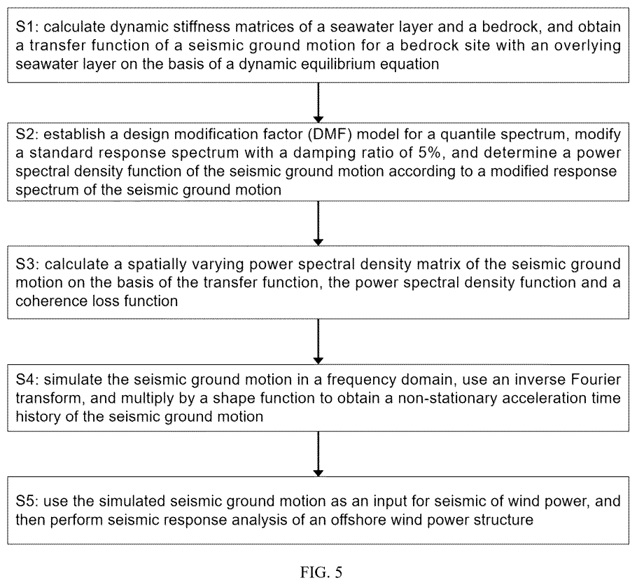

The disclosure provides a simulation method for a marine seismic ground motion applicable to seismic analysis of offshore wind power, with the flowchart as shown in FIG. 5. The specific steps of the method are as follows.

Step S1: Obtaining a Transfer Function of a Seismic Ground Motion for a Bedrock Site with an Overlying Seawater Layer

Assuming seawater is an ideal fluid incapable of withstanding a shear stress and capable of only propagating compressional waves (P waves) rather than shear waves (S waves), a motion under seismic excitation is expressed using a fluid mass conservation equation, an Euler equation and a thermodynamic equation, a partial differential equation is solved to obtain displacement and stress expressions for mass points at a top and a bottom of the seawater layer, and on the basis of a relationship between displacement and load, the dynamic stiffness matrices and the dynamic equilibrium equation are obtained; and the dynamic stiffness matrices and the dynamic equilibrium equation are integrated to obtain the transfer function of the seismic ground motion for the bedrock site with the overlying seawater layer.

### Step S2: Determining a Power Spectral Density Function of the Seismic Ground Motion

On the basis of a seismic ground motion selection criterion with a minimum deviation between an average response spectrum and a design spectrum of a wind turbine tower, statistical regression is performed to establish a DMF model for a quantile spectrum, a standard response spectrum with a damping ratio of 5% in a code is modified, and then the power spectral density function of the seismic ground motion is determined on the basis of a modified response spectrum of the seismic ground motion.

### Step S3: Solving a Spatially Varying Power Spectral Density Matrix of the Seismic Ground Motion

The spatially varying power spectral density matrix of the seismic ground motion is calculated on the basis of the transfer function, the power spectral density function and a coherence loss function.

The power spectral density function is solved on the basis of the response spectrum obtained in step S2:

$$S ( ω ) = - \frac{ξ}{π ω} \frac{{S}_{a}^{2} ( ω , ξ )}{ln ( - \frac{π}{{T}_{d} ω} ln P )} ;$$

in the formula, ξ is a damping ratio, Sₐ²(ω, ξ) is a seismic acceleration response spectrum, T_{d} is a seismic duration, P is a probability which does not exceed a target response spectrum, typically taken as 0.85; and ω represents a circular frequency.

A self-power spectral density function at a point a of the site is:

$${S}_{a a} ( ω ) = {\vert {H}_{a} ( i ω ) \vert}^{2} {S}_{b r} ( ω ) ;$$

in the formula, |Hₐ(iω)| represents a transfer function of the seismic ground motion at the point a, S_{br}(ω) represents a power spectral density function of the seismic ground motion on a free surface of the bedrock, and br represents the related properties of the bedrock; and i represents an imaginary unit, used for processing a transfer function of the seismic ground motion in complex form.

A cross-power spectral density function S_{ab}(iω) of the seismic ground motion between points a and b is:

$${S}_{a b} ( i ω ) = {H}_{a} ( i ω ) {H}_{b}^{*} ( i ω ) {γ}_{{a}^{′} {b}^{′}} ( i ω ) {S}_{b r} ( ω ) ;$$

in the formula, a superscript * represents a complex conjugate; Hₐ(iω) represents a transfer function of the seismic ground motion at the point a, describing a variation of a seismic wave transmitted from the bedrock to the point a; H*_{b}(iω) represents a complex conjugate of a transfer function of a seismic ground motion at a point b, for processing a relationship between phase and amplitude of a seismic ground motion signal in the frequency domain; and γ_{a′b′}(iω) represents a coherent loss function between the points a and b of the bedrock.

A power spectral density function matrix S(iω) of the seismic ground motion for n points in the site is obtained:

$$S ( i ω ) = [ \begin{matrix}{S}_{11} ( ω ) & … & {S}_{1 n} ( ω ) \\ ⋮ & ⋱ & ⋮ \\ {S}_{n 1} ( ω ) & … & {S}_{nn} ( ω )\end{matrix} ] .$$

### Step S4: Simulating Acceleration Time History of the Seismic Ground Motion

The seismic ground motion is simulated in a frequency domain, an inverse Fourier transform is used, and a shape function is multiplied to obtain a non-stationary acceleration time history of the seismic ground motion. A power spectral density function matrix of the seismic ground motion obtained in step S3 is decomposed to obtain a lower triangular complex matrix L(iω) and a Hermitian matrix L^{H}(iω):

$$S ( i ω ) = L ( i ω ) {L}^{H} ( i ω ) ;$$

a seismic ground motion at the point a can be simulated in a frequency domain:

$${U}_{a} ( i {ω}_{n} ) = {\sum }_{m = 1}^{a} {B}_{a m} ( {ω}_{n} ) [ cos {α}_{a m} ( {ω}_{n} ) + i sin {α}_{a m} ( {ω}_{n} ) ] , n = 1 , 2 , … , N ;$$

$${B}_{a m} ( {ω}_{n} ) = \sqrt{△ω} \vert {L}_{a m} ( i {ω}_{n} ) \vert ;$$

$${α}_{a m} ( {ω}_{n} ) = {tan}^{- 1} ( \frac{I m [ {L}_{a m} ( i {ω}_{n} ) ]}{Re [ {L}_{a m} ( i {ω}_{n} ) ]} ) + {φ}_{m n} ( {ω}_{n} ) ;$$

in the formulas, Bₐₘ(ωₙ) is an amplitude of a simulated seismic ground motion, aₐₘ(ωₙ) is a phase angle of the simulated seismic ground motion, Δω is a frequency interval, Lₐₘ(iωₙ) is an element in a matrix L(iω) corresponding to a frequency ωₙ and a position am, containing amplitude and phase information of the seismic ground motion, where a represents a specific spatial point, and m represents a corresponding frequency component; φₘₙ(ωₙ) is a uniformly distributed random variable within an interval of [0, 2π]; a numerator Iₘ[Lₐₘ(iωₙ)] represents an imaginary part of Lₐₘ(iωₙ); and a denominator Re[Lₐₘ(iωₙ)] represents a real part of Lₐₘ(iωₙ).

The inverse Fourier transform is performed on Uₐ(iωₙ) to obtain a stationary seismic ground motion acceleration uₐ(t) at the point a in a time domain, and uₐ(t) is multiplied by an intensity envelope function to obtain a final simulated non-stationary acceleration time history of the seismic ground motion at the point a.

### Step S5: Performing Seismic Response Analysis of Wind Power Tower

A finite element model of the wind power structure is established in OpenSees software, a simulated acceleration time history of the seismic ground motion is used as an input to calculate structural responses such as a tower-top displacement, a tower-top acceleration and a tower-bottom internal force of the wind power structure under a seismic action.

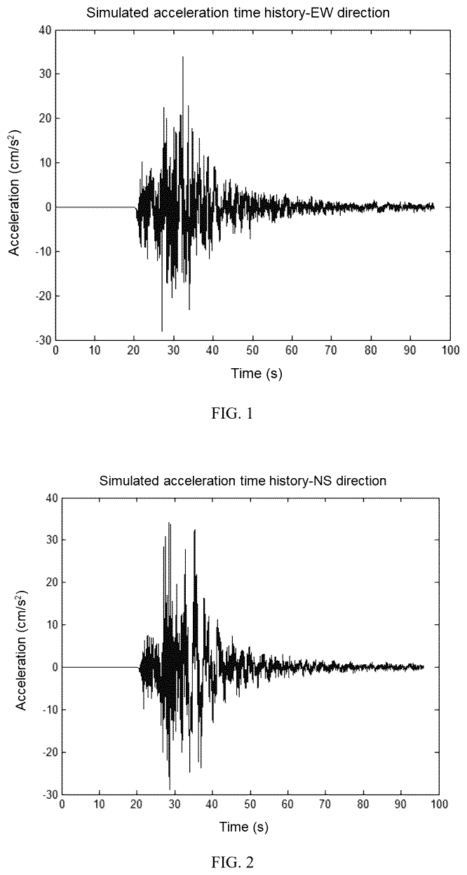

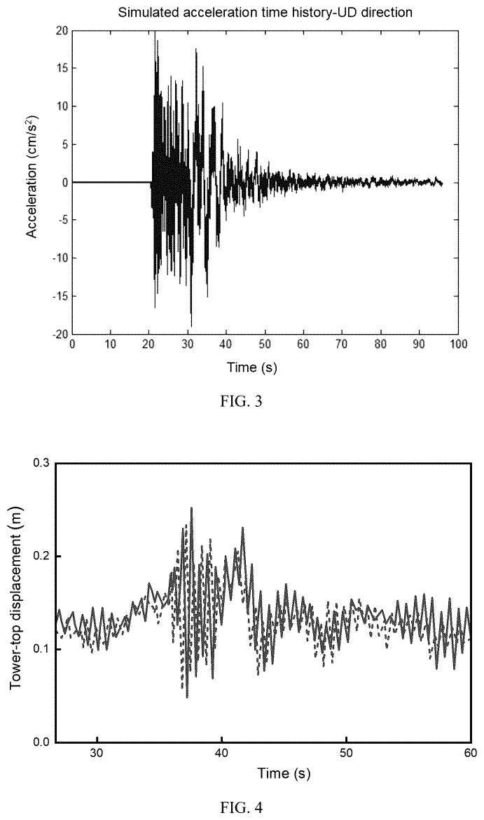

The seismic ground motion (EW direction) simulated by the method of the disclosure is shown in FIG. 1, the seismic ground motion (NS direction) simulated is shown in FIG. 2, and the seismic ground motion (UD direction) simulated is shown in FIG. 3. FIG. 4 shows a tower-top displacement of a 1.5 MW wind power tower under a simulated seismic ground motion.

1. A simulation method for a marine seismic ground motion applicable to seismic analysis of offshore wind power, performed by a computer device, and comprising the following steps:
step S1: calculating dynamic stiffness matrices of a seawater layer and a bedrock, and obtaining a transfer function of a seismic ground motion for a bedrock site with an overlying seawater layer on the basis of a dynamic equilibrium equation;
step S2: on the basis of a seismic ground motion selection criterion with a minimum deviation between an average response spectrum and a design spectrum of a wind turbine tower, performing statistical regression to establish a design modification factor (DMF) model for a quantile spectrum, modifying a standard response spectrum with a damping ratio of 5% in a code, and then determining a power spectral density function of the seismic ground motion according to a modified response spectrum of the seismic ground motion;
step S3: calculating a spatially varying power spectral density matrix of the seismic ground motion on the basis of the transfer function, the power spectral density function and a coherence loss function;
step S4: simulating the seismic ground motion in a frequency domain, using an inverse Fourier transform, and multiplying by a shape function to obtain a non-stationary acceleration time history of the seismic ground motion;
decomposing a power spectral density function matrix of the seismic ground motion obtained in step S3 to obtain a lower triangular complex matrix L (id) and a Hermitian matrix L^{H}(iω):
S(iω)=L(iω)L^{H}(iω);
wherein S(iω) is a power spectral density function matrix of the non-stationary acceleration time history;
simulating the seismic ground motion at a point a in the frequency domain:
$${U}_{a} ( i {ω}_{n} ) = {\sum }_{m = 1}^{a} {B}_{a m} ( {ω}_{n} ) [ cos {α}_{a m} ( {ω}_{n} ) + i sin {α}_{a m} ( {ω}_{n} ) ] , n = 1 , 2 , … , N ;$$
$${B}_{a m} ( {ω}_{n} ) = \sqrt{△ω} \vert {L}_{a m} ( i {ω}_{n} ) \vert ;$$
$${α}_{a m} ( {ω}_{n} ) = {tan}^{- 1} ( \frac{I m [ {L}_{a m} ( i {ω}_{n} ) ]}{Re [ {L}_{a m} ( i {ω}_{n} ) ]} ) + {φ}_{m n} ( {ω}_{n} ) ;$$
in the formulas, Bₐₘ(ωₙ) is an amplitude of a simulated seismic ground motion, aₐₘ(ωₙ) is a phase angle of the simulated seismic ground motion, Δω is a frequency interval, Lₐₘ(ωₙ) is an element in a matrix L(iω) corresponding to a frequency ωₙ and a position am, containing amplitude and phase information of the seismic ground motion, where a represents a specific spatial point, and m represents a corresponding frequency component; φₘₙ(ωₙ) is a uniformly distributed random variable within an interval of [0, 2π]; a numerator lm[Lₐₘ(iωₙ)] represents an imaginary part of Lₐₘ(iωₙ); and a denominator Re [Lₐₘ(iωₙ)] represents a real part of Lₐₘ(iωₙ); and
performing the inverse Fourier transform on Uₐ(iωₙ) to obtain a stationary seismic ground motion acceleration uₐ(t) at the point a in a time domain, multiplying uₐ(t) by an intensity envelope function to obtain a final simulated non-stationary acceleration time history of the seismic ground motion at the point a; and
step S5: using the simulated seismic ground motion as an input for seismic of wind power, and then performing seismic response analysis of an offshore wind power structure to obtain seismic response analysis results;
step S6: on the basis of the seismic response analysis results, optimizing the offshore wind power structure to obtain an optimized offshore wind power structure; and
step S7: on the basis of the optimized offshore wind power structure, constructing an offshore wind farm.

2. The simulation method for a marine seismic ground motion applicable to seismic analysis of offshore wind power according to claim 1, wherein in step S1, assuming seawater is an ideal fluid incapable of withstanding a shear stress and capable of only propagating compressional waves rather than shear waves, a motion under seismic excitation is expressed using a fluid mass conservation equation, an Euler equation and a thermodynamic equation, a partial differential equation is solved to obtain displacement and stress expressions for mass points at a top and a bottom of the seawater layer, and on the basis of a relationship between the displacement and load, the dynamic stiffness matrices and the dynamic equilibrium equation are obtained; and the dynamic stiffness matrices and the dynamic equilibrium equation are integrated to obtain the transfer function of the seismic ground motion for the bedrock site with the overlying seawater layer.

3. The simulation method for a marine seismic ground motion applicable to seismic analysis of offshore wind power according to claim 1, wherein in step S3, the power spectral density function is solved on the basis of the response spectrum obtained in step S2:
$$S ( ω ) = - \frac{ξ}{π ω} \frac{{S}_{a}^{2} ( ω , ξ )}{ln ( - \frac{π}{{T}_{d} ω} ln P )} ;$$
in the formula, ξ is a damping ratio, Sₐ²(ω, ξ) is a seismic acceleration response spectrum, T_{d} is a seismic duration, P is a probability which does not exceed a target response spectrum; and ω represents a circular frequency; S(ω) is the power spectral density function;
a self-power spectral density function at the point a of the site is:
$${S}_{a a} ( ω ) = {\vert {H}_{a} ( i ω ) \vert}^{2} {S}_{b r} ( ω ) ;$$
in the formula, |Hₐ(iω)| represents a transfer function of the seismic ground motion at the point a, S_{br}(ω) represents a power spectral density function of the seismic ground motion on a free surface of the bedrock; and i represents an imaginary unit; Sₐₐ(ω) is the self-power spectral density function;
a cross-power spectral density function S_{ab}(iω) of the seismic ground motion between points a and b is:
$${S}_{a b} ( i ω ) = {H}_{a} ( i ω ) {H}_{b}^{*} ( i ω ) {γ}_{{a}^{′} {b}^{′}} ( i ω ) {S}_{b r} ( ω ) ;$$
in the formula, a superscript * represents a complex conjugate; Hₐ(iω) represents a transfer function of the seismic ground motion at the point a, describing a variation of a seismic wave transmitted from the bedrock to the point a; H*_{b}(iω) represents a complex conjugate of a transfer function of a seismic ground motion at a point b, for processing a relationship between phase and amplitude of a seismic ground motion signal in the frequency domain; and γ_{a′b′}(iω) represents a coherent loss function between the points a and b of the bedrock; and
a power spectral density function matrix S(iω) of the seismic ground motion for n points in the site is obtained:
$$S ( i ω ) = [ \begin{matrix}{S}_{11} ( ω ) & … & {S}_{1 n} ( ω ) \\ ⋮ & ⋱ & ⋮ \\ {S}_{n 1} ( ω ) & … & {S}_{nn} ( ω )\end{matrix} ] .$$

4. The simulation method for a marine seismic ground motion applicable to seismic analysis of offshore wind power according to claim 1, wherein in step S5, a finite element model of the wind power structure is established in OpenSees software, a simulated acceleration time history of the seismic ground motion is used as an input to calculate a tower top displacement, a tower top acceleration and a tower bottom internal force of the wind power structure under a seismic action.
